(19) United States
(12) Patent Application Publication
(10) Pub. No.: US 2021/0350224 A1
(43) Pub. Date: Nov. 11, 2021

(54) METHODS AND SYSTEMS FOR EVALUATING A NEW APPLICATION

(71) Applicant: Capital One Services, LLC, McLean, VA (US)

(72) Inventors: Austin WALTERS, Savoy, IL (US); Anh TRUONG, Champaign, IL (US); Reza FARIVAR, Champaign, IL (US); Vincent PHAM, Champaign, IL (US); Jeremy GOODSITT, Champaign, IL (US); Galen RAFFERTY, Mahomet, IL (US)

(73) Assignee: Capital One Services, LLC, McLean, VA (US)

(21) Appl. No.: 16/869,871

(22) Filed: May 8, 2020

(51) Int. Cl. G06N 3/08; G06F 9/54; G06F 16/28; G06N 3/04

(52) U.S. Cl. CPC G06N 3/08; G06N 3/04; G06F 16/285; G06F 9/541

(57) ABSTRACT

A computer-implemented method may include: receiving a plurality of documents, wherein each of the plurality of documents includes a description of an application and an objective of the application; extracting the objective of the application from each of the received plurality of documents; clustering the plurality of documents to generate at least a first cluster of documents and a second cluster of documents; determining a first set of attributes associated with each of the documents included in the first cluster of documents and a second set of attributes associated with each of the documents included in the second cluster of documents; and training a classification engine based on the plurality of documents, the extracted objectives, the first set of attributes, and the second set of attributes.

### TECHNICAL FIELD

Various embodiments of the present disclosure relate generally to determining relationships between performance indicators for projects and usage records for the projects, and, more particularly, to identifying performance indicators associated with a project based on text descriptive of the project and using the determined relationship to generate a quantitative assessment of the performance indicators for each project.

### BACKGROUND

Entities such as businesses, enterprises, organizations, and the like, commonly use key performance indicators (“KPI″s”) to assess performance within the entity. A KPI is a quantifiable measure usable to evaluate a particular goal of the entity such as total customers, reduction in costs, market share, etc. However, an entity may be planning and/or engaged in any multitude of different projects, each of which may be associated with progress toward one or more KPIs which may or may not overlap. Thus, KPIs, although generally associated with goals of the entity overall, are of little aid in planning or assessing projects.

The present disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for evaluating a new application.

In one aspect, a computer-implemented method may include: receiving, via one or more processors, a plurality of documents, wherein each of the plurality of documents includes a description of an application and an objective of the application; extracting, via the one or more processors, the objective of the application from each of the received plurality of documents; clustering, via the one or more processors, the plurality of documents to generate at least a first cluster of documents and a second cluster of documents; determining, via the one or more processors, a first set of attributes associated with each of the documents included in the first cluster of documents and a second set of attributes associated with each of the documents included in the second cluster of documents; training, via the one or more processors, a classification engine based on the plurality of documents, the extracted objectives, the first set of attributes, and the second set of attributes; receiving, via the one or more processors, a new document including a description of a new application and an objective of the new application; using, via the one or more processors, the classification engine to generate a set of attributes associated with the new document; determining, via the one or more processors, a mapping of the set of attributes associated with the new document, the new application, and the objective of the new application; assigning, via the one or more processors, the new application to a server and operating the new application on the server; determining, via the one or more processors, a number of access requests to the server via an application program interface (API) of the server; and evaluating, via the one or more processors, the new application based on the determined number of access requests to the server and the mapping.

In another aspect, a non-transitory computer-readable medium may contain instructions that, when executed by a processor, cause the processor to perform a method including: receiving a plurality of documents, wherein each of the plurality of documents includes a description of an application and an objective of the application; extracting the objective of the application from each of the received plurality of documents; clustering the plurality of documents to generate at least a first cluster of documents and a second cluster of documents; determining a first set of attributes associated with each of the documents included in the first cluster of documents and a second set of attributes associated with each of the documents included in the second cluster of documents; training a classification engine based on the plurality of documents, the extracted objectives, the first set of attributes, and the second set of attributes; receiving a new document including a description of a new application and an objective of the new application; using the classification engine to generate a set of attributes associated with the new document; determining a mapping of the set of attributes associated with the new document, the new application, and the objective of the new application; assigning the new application to a server and operating the new application on the server; determining a number of access requests to the server via an API of the server; and evaluating the new application based on the determined number of access requests to the server and the mapping.

In yet another aspect, a computer-implemented method may include: receiving, via one or more processors, a plurality of documents, wherein each of the plurality of documents includes a description of an application and an objective of the application; extracting, via the one or more processors, the objective of the application from each of the received plurality of documents; clustering, via the one or more processors, the plurality of documents to generate at least a first cluster of documents and a second cluster of documents; determining, via the one or more processors, a first set of attributes associated with each of the documents included in the first cluster of documents and a second set of attributes associated with each of the documents included in the second cluster of documents; training, via the one or more processors, a classification engine based on the plurality of documents, the extracted objectives, the first set of attributes, and the second set of attributes; receiving, via the one or more processors, a first new document including a first description of a first new application and an objective of the first new application; using, via the one or more processors, the classification engine to generate a set of attributes associated with the first new document; determining, via the one or more processors, a first mapping of the set of attributes associated with the first new document, the first new application, and the objective of the first new application; assigning, via the one or more processors, the first new application to a first server and operating the first new application on the first server; determining, via the one or more processors, a number of access requests to the first server via an API of the first server; receiving, via the one or more processors, a second new document including a second description of a second new application and an objective of the second new application; using, via the one or more processors, the classification engine to generate a set of attributes associated with the second new document; determining, via the one or more processors, a second mapping of the set of attributes associated with the second new document, the second new application, and the objective of the second new application; assigning, via the one or more processors, the second new application to a second server and operating the second new application on the second server; determining, via the one or more processors, a number of access requests to the second server via an API of the second server; and evaluating, via the one or more processors, the first new application and the second new application based on the number of access requests to the first server, the number of access requests to the second server, the first mapping, and the second mapping, wherein evaluating the first new application and the second new application comprises comparing the determined number of access requests to the first server and the determined number of access requests to the second server.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure, according to one or more embodiments.

FIG. 2 depicts a flowchart of an exemplary method of classifying a new document with a trained classifier, and tracking success of a project associated with the new document, according to one or more embodiments.

FIG. 3 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In the following description, embodiments will be described with reference to the accompanying drawings. As will be discussed in more detail below, in various embodiments, data such as a plurality of documents, a first set of attributes, or a number of access requests may be used to evaluate a new application.

In an exemplary use case, an entity such as a business, enterprise, organization, or the like, may use key performance indicators (“KPI”s) to evaluate performance within the entity. The entity may be planning and/or conducting a plurality of different projects. However, it may be difficult to readily ascertain which KPI(s) may be impacted by any particular project. Further, it is generally impractical and/or inefficient for an entity to pursue and/or continue to fund every project. However, there may be overlap of association with KPIs across projects, and thus it may be difficult to identify which project(s) to maintain in order to better improve progress towards KPIs overall.

KPIs associated with a particular project may be automatically determined based on information associated with the project. Each project may be associated with a statement of work, e.g., a document that includes text descriptive of the project. For example, a statement of work may include text associated with objectives, deliverables, requirements, or other information associated with a corresponding project. KPIs may be assigned to a project based on the text in an associated statement of work. For example, a classifier, a natural language processor, or the like may associate one or more KPIs with one or more portions of the text.

Usage records for projects may be tracked over time. A usage record may include any suitable quantifiable measure for a success of a project. For example, a project may be associated with a product that may be purchased, and the number of sales, the total profit, or the like may be tracked. In another example, an electronic application that may be executed, e.g., via users on mobile devices, and various aspects like number of users, number of times the application was executed, total revenue, or the like may be tracked.

Since each project may be associated with one or more KPIs, the usage records for the projects may be indicative of a quantifiable measure of how each project is impacting various KPIs. Such information may be used, for example, in order to identify projects that are associated with KPIs that are under-represented by other projects from the entity, or in order to quantitatively compare projects that are associated with overlapping KPIs. For example, two projects may each be associated with a KPI for training employees of the entity in java code development. The usage records for the projects indicate that one project was more successful than the other, and thus may indicate that the one project is more beneficial to the java code development KPI than the other. Since entities may have limited resources, being able to quantitatively assess how projects are contributing to various KPIs may be beneficial for determining allocation of resources and/or project planning and management.

In another exemplary use case, a classifier for associating KPIs with projects based on text within statements of work may include an algorithm and/or a machine learning model. For example, statements of work for various projects may be clustered based on the text within the documents. Any suitable clustering process may be used. In some embodiments, a natural language processing technique is used to identify keywords and/or most unique words in the text, e.g., by eliminating stop words, extracting one or more of nouns and verbs, and/or the like. One or more KPIs may then be assigned as labels to each cluster.

In some embodiments, KPIs may be assigned manually. In some embodiments, KPIs may be assigned based on an algorithm. For example, text of the documents in each cluster may be compared in order to determine a list of most-common words in the text of the documents in each cluster. The most-common words in each cluster may then be compared with a predetermined list of KPIs, and KPIs with text matching the most-common words may be assigned as labels to the cluster. The KPI labels for each cluster and the text samples of the documents in each cluster may then be used as ground truth for training a machine learning model configured to assign one or more KPI labels based on input text.

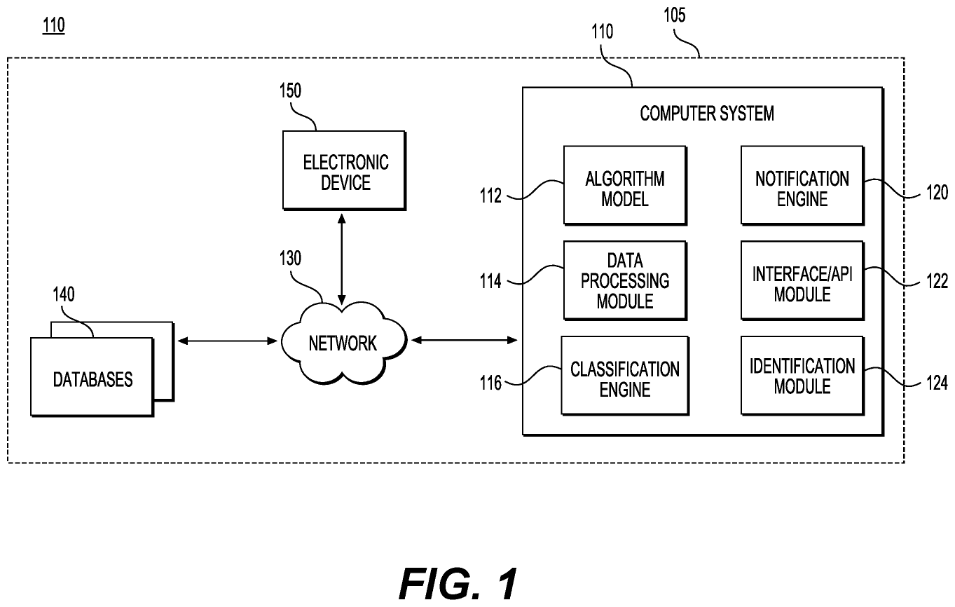

FIG. 1 is a diagram depicting an example of a system environment 100 according to one or more embodiments of the present disclosure. The system environment 100 may include a computer system 110, a network 130, one or more databases for collecting and storing data (e.g., a plurality of documents) 140, and an electronic device 150. These components may be connected to (e.g., in communication with) one another via the network 130.

The computer system 110 may have one or more processors configured to perform methods described in this disclosure. The computer system 110 may include one or more modules, models, or engines. The one or more modules, models, or engines may include an algorithm model 112, a data processing module 114, a classification engine 116, a notification engine 120, an interface/API module 122, and/or an identification module 124, which may each be software components stored in/by the computer system 110. The computer system 110 may be configured to utilize one or more modules, models, or engines when performing various methods described in this disclosure. In some examples, the computer system 110 may have a cloud computing platform with scalable resources for computation and/or data storage, and may run one or more applications on the cloud computing platform to perform various computer-implemented methods described in this disclosure. In some embodiments, some of the one or more modules, models, or engines may be combined to form fewer modules, models, or engines. In some embodiments, some of the one or more modules, models, or engines may be separated into separate, more numerous modules, models, or engines. In some embodiments, some of the one or more modules, models, or engines may be removed while others may be added.

The algorithm model 112 may be a plurality of algorithm models. The algorithm model 112 may include a trained machine learning model. In some embodiments, the algorithm model 112 may include a classification module. In other embodiments, the algorithm model 112 may not include a classification engine, and the algorithm model 112 may execute algorithms other than the algorithm used by classification engine 116. Details of algorithm model 112 are described elsewhere herein.

The data processing module 114 may be configured to extract, monitor, track, clean, process, or standardize data (e.g., a plurality of documents and/or usage records of projects). One or more algorithms may be used to clean, process, or standardize the data. The classification engine 116 may include a trained machine learning model to classify different data (e.g., apply labels to one or more documents). The notification engine 120 may be configured to generate and communicate (e.g., transmit) one or more notifications (e.g., the classification(s) of a document and/or usage records of a project) to an electronic device 150 via network 130. The interface/API module 122 may allow a user of the computer system 110 to interact with one or more modules, models, or engines of the computer system 110. The identification module 124 may manage identification data for a user or any individual accessing the computer system 110. In one implementation, the identification data may be stored to, and retrieved from, one or more components of the data storage associated with an entity 105 or computer system 110.

Computer system 110 may be configured to receive data from other components (e.g., databases 140 or electronic device 150) of the system environment 100 via network 130. Computer system 110 may further be configured to utilize the received data by inputting the received data into the algorithm model 112, the classification engine 116, or the data processing module 114 to produce a result (e.g., a classification for a document, a usage record, a KPI score for a project, etc.). Information indicating the result may be transmitted to an electronic device 150 over network 130 via notification engine 120. In some examples, the computer system 110 may be referred to as a server system that provides a service including providing the information indicating the received data and/or the result to an electronic device 150.

Network 130 may be any suitable network or combination of networks, and may support any appropriate protocol suitable for communication of data to and from the computer system 110 and between various other components in the system environment 100. Network 130 may include a public network (e.g., the Internet), a private network (e.g., a network within an organization), or a combination of public and/or private networks. Network 130 may be configured to provide communication between various components depicted in FIG. 1. Network 130 may comprise one or more networks that connect devices and/or components of environment 100 to allow communication between the devices and/or components. For example, the network 130 may be implemented as the Internet, a wireless network, a wired network (e.g., Ethernet), a local area network (LAN), a Wide Area Network (WANs), Bluetooth, Near Field Communication (NFC), or any other type of network that provides communications between one or more components of environment 100. In some embodiments, network 130 may be implemented using cell and/or pager networks, satellite, licensed radio, or a combination of licensed and unlicensed radio. Network 130 may be associated with a cloud platform that stores data and information related to methods disclosed herein.

Electronic device 150 may operate a client program used to communicate with the computer system 110. The electronic device 150 may be used by a user or any individual (e.g., an employee at a financial service provider) employed by, or otherwise associated with computer system 110, or entity 105. Such an individual may participate and perform one or more activities in the process of evaluating the new application via the electronic device 150. The client application may be used to provide information (e.g., a plurality of documents) to the computer system 110 and to receive information from the computer system 110. In some examples, the client application may be a mobile application that is run on electronic device 150. Electronic device 150 may be a mobile device (e.g., smartphone, tablet, pager, personal digital assistant (PDA)), a computer (e.g., laptop computer, desktop computer, server), or a wearable device (e.g., smart watch). Electronic device 150 can also include any other media content player, for example, a set-top box, a television set, a video game system, or any electronic device capable of providing or rendering data. Electronic device 150 may optionally be portable. Electronic device 150 may be handheld. Electronic device 150 may be a network device capable of connecting to a network, such as network 130, or other networks such as a local area network (LAN), wide area network (WAN) such as the Internet, a telecommunications network, a data network, or any other type of network.

Databases 140 may store any data associated with any entity, including, but not limited to, financial services providers, or other entities. An entity may include one or more databases to store any information related to a transaction by a user, an electronic application accessed by the user, or the user. In some embodiments, the entity may provide a platform (e.g., an electronic application on an electronic device) with which a user or an operator can interact. Such interactions may provide data (e.g., usage records) that may be analyzed or used in the methods disclosed herein.

In some embodiments, the entity may include on-line resources including webpage, e-mail, applications, or social network sites. On-line resources may be provided by manufacturers, retailers, consumer promotion agencies, and other entities. In some embodiments, the entity may include a merchant. Other entities may include merchants that may each be an entity that provides products. The term “product,” in the context of products offered by a merchant, encompasses both goods and services, as well as products that are a combination of goods and services. A merchant may be, for example, a retailer, a vehicle dealer, a grocery store, an entertainment venue, a service provider, a restaurant, a bar, a non-profit organization, or other type of entity that provides products that a consumer may consume. A merchant may have one or more venues that a consumer may physically visit in order to obtain the products (goods or services) offered by the merchant.

Computer system 110, databases 140 and/or electronic device 150 may be part of an entity 105, which may be any type of company, organization, institution, enterprise, or the like. In some examples, entity 105 may be a financial services provider, a provider of a platform such as an electronic application accessible over network 130, or the like. In such examples, the computer system 110 and/or operator device 160 may have access to data pertaining to a communication through a private network within the entity 105. In some cases, the computer system 110 may have access to data collected by electronic device 150.

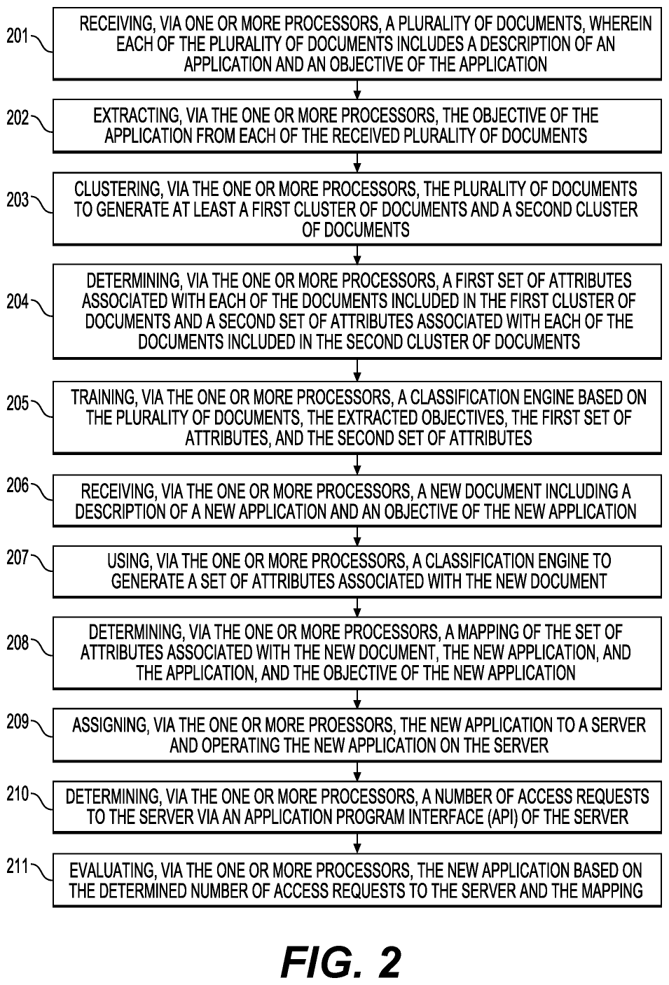

FIG. 2 is a flowchart illustrating a method for training a classifier, classifying a new document with the trained classifier, and tracking usage of an electronic application associated with the new document, according to one or more embodiments of the present disclosure. The method may be performed by computer system 110.

Step 201 may include receiving, via one or more processors, a plurality of documents. The documents may be, for example, statements of work that are each associated with a respective project. Each document may include text, such as text descriptive of the respective project. The text may include a description of a product or an electronic application associated with the project, an objective or goal of the project, or the like. Each of the documents may be of any type, such as a direct mail, an e-mail, a text file, or the like.

Step 202 may include extracting, via the one or more processors, at least a portion of text from the plurality of documents. The portion of text may include, for example, objectives or goals for the projects, key words, or the like. In some examples, the extraction may include employment of a natural language processing technique. In some examples, stop words or other predetermined words or types of words are exempted from the extraction. In some examples a particular type of words, such as verbs or nouns, are selectively extracted. In some examples, no extraction is performed. In some examples, the extraction may include identifying and extracting the objectives or goals from each of the received plurality of documents.

Step 203 may include clustering, via the one or more processors, the plurality of documents into a plurality of clusters. Any suitable clustering process may be used, and the documents may be clustered into any number of clusters. In an example, the documents may be clustered into at least a first cluster of documents and a second cluster of documents. The clustering may be based on the text of the documents. The clustering may be based on the extracted portions of the texts, such as the extracted objectives in step 202. In some examples, the clustering of the plurality of documents to generate at least the first cluster of documents and the second cluster of documents may comprise clustering at least the first and second clusters of documents based on overlapping key words used in each of the plurality of documents. In other words, the clusters may respectively include a cluster of documents that each include at least some keywords in common, or that include more keywords in common than other documents not in the cluster.

Step 204 may include determining, via the one or more processors, a first set of attributes associated with each of the documents included in the first cluster of documents and a second set of attributes associated with each of the documents included in the second cluster of documents. As used herein, an “attribute” generally encompasses a label, a feature (e.g., a feature constituent of a feature vector), a tag, or the like. The first set of attributes associated with each of the documents included in the first cluster of documents may correspond to one or more KPIs, and thus the determining of the first set of attributes includes associating the documents in the first cluster with the one or more KPIs. The second set of attributes associated with each of the documents included in the second cluster of documents may correspond to one or more KPIs, and thus the determining of the second set of attributes includes associating the documents in the second cluster with the one or more KPIs. A further set of attributes may be determined for each cluster.

Determining a set of attributes for a cluster of documents may include identifying a plurality of overlapping key words used in the text of each of the documents included in the cluster; and determining one or more KPIs based on the identified plurality of overlapping keywords. Determining one or more KPIs based on the identified plurality of overlapping keywords may include receiving a mapping of a plurality of KPIs and a plurality of key words; and using the received mapping to determine the one or more KPIs based on the identified plurality of overlapping key words.

Step 205 may include training, via the one or more processors, a classification engine (e.g., classification engine 116) based on the text of the plurality of documents, extracted objectives, and the sets of attributes of the clusters. The classification engine 116 may include one or more neural networks. A neural network may be software representing a human neural system (e.g., cognitive system). A neural network may include a series of layers termed “neurons” or “nodes.” A neural network may comprise an input layer, to which data is presented; one or more internal layers; and an output layer. The number of neurons in each layer may be related to the complexity of a problem to be solved. Input neurons may receive data being presented and then transmit the data to the first internal layer through connections' weight. A neural network may include, for example, a convolutional neural network, a deep neural network, or a recurrent neural network. Any suitable type of neural network may be used.

In some examples, the classification engine 116 may accept the text of the documents as input samples, and the cluster associated with the documents as a ground truth classification. In some examples, the classification engine 116 may accept the sets of attributes of the clusters as the ground truth classification. Once trained, the classification engine 116 may be configured to accept a new document as input, and at least one of assign the new document to a cluster, associate the new document with the set of attributes associated with the assigned cluster, and associate the new document with one or more KPIs. Thus, a trained classification engine 116 according to this disclosure may facilitate rapidly and automatically associating new documents with attributes. In an example, a new statement of work for a project may be rapidly and automatically associated with KPIs for an entity.

Step 206 may include receiving, via the one or more processors, a new document such as, for example, a new statement of work including text with a description of a new project, a goal or objective of the new project, and/or an electronic application associated with the project. The new document may be generated by one or more algorithms or a user (e.g., an employee of an entity).

Step 207 may include using, via the one or more processors, the classification engine 116 to generate a set of attributes associated with the new document. The classification engine 116 may compute the set of attributes associated with the new document as a function of the text of the new document or at least a portion of the text of the new document. For example, the classification engine 116 may map one or more KPIs to the new statement of work, and thus associate the new project with the mapped KPIs.

Step 208 may include determining, via the one or more processors, a mapping of the set of attributes associated with the new document, the new project, and the objective of the new application.

In some examples, the new project may be associated with a new electronic application. Step 209 may include assigning, via the one or more processors, the new application to a server and operating the new application on the server.

Step 210 may include determining, via the one or more processors, usage records for the project. For example, a number of access requests to the server via an application program interface (API) of the server may be tracked. Determining the number of access requests to the server via the API of the server may include obtaining an access log to the server; and analyzing the access log to determine the number of access requests. Any suitable type of usage record may be used. For example, total sales, a number of users, or any other suitable statistics or indicators of success may be used.

Step 211 may include evaluating the new project and/or the associated new application by mapping the number of access requests to the mapping of the set of attributes associated with the new document, the new application, and/or the objective of the new application. In other words, each usage of the project, e.g., each execution of the application, may be mapped as an increase to a score for the attributes associated with the project. As noted above, the set of attributes associated with the new document may include one or more KPIs associated with the new document, and thus the scores may be a quantitative indication as to the contribution of the project to the associated KPIs. The higher the usage records, the higher the associated scores, and thus the higher the quantitative indication of contribution to the associated KPIs.

In some examples, goals or objectives for a project may be quantitatively measured. For example, total sales, profits, users, etc., may be associated with a goal or objective of a project. In some examples, goals or objectives may be associated with corresponding KPIs. In some embodiments, scores may be generated that are indicative of the fulfillment of a goal or objective.

The method may further include transmitting, to the user, a notification indicating the evaluation. The notification may include any information associated with the evaluation. The notification may be configured to be displayed on a display screen of a user device associated with the user (e.g., electronic device 150). The notification may be displayed on the display screen in any suitable form, such as an e-mail, a text message, a push notification, content on a web page, and/or any form of graphical user interface. The electronic device 150 may be capable of accepting inputs of a user via one or more interactive components of the electronic device 150, such as a keyboard, button, mouse, touchscreen, touchpad, joystick, trackball, camera, microphone, or motion sensor.

In an example, a display generated for the electronic device 150 according to this disclosure may include a listing of projects for the entity. The listing may include, for each project, a listing of the goals and/or objectives extracted from the text of the documents. The listing may include, for each project, the scores for the associated set of attributes, e.g., scores for KPIs associated with the projects. The listing may include a graphical indication of the scores, such as a bar, a color icon, or any suitable graphic. The display may be configured to group arrangement of the projects in the display based on the clusters assigned to the projects. The display may be configured to enable a user to directly compare the scores of different projects. The display may include a summation of scores for each KPI.

In an exemplary use case, a user may be able to use the display to, for example, determine that a particular KPI is under-represented in the projects for the entity. Such a determination may assist in the making of a decision with regard to current or future projects to pursue. For example, projects associated with an over-represented KPI may be given less priority, and projects associated with an under-represented KPI may be given more priority.

In another exemplary use case, a user may be able to evaluate and compare projects that are associated with overlapping KPIs. For example, the display may indicate that two projects are both associated with a KPI-1, but that a first project has a higher score than a second project. This indication may assist in making a decision as to which of the two overlapping projects to prioritize. Any suitable criteria may be used to rank, sort, and evaluate projects, either individually or relative to other projects. In some examples, projects may be ranked, prioritized, or selected for funding or termination via an algorithm. For example, an algorithm may be configured to optimize a score for a particular KPI or particular KPIs, or to optimize a total summation of all scores. The algorithm may be configured to optimize for other factors in conjunction with score(s), such as cost per project, available funds, personnel, resources, or the like.

The method may further include storing any information, including the new application and/or the new document for subsequent analysis. The stored information may have an expiration period. The expiration period may be at least 1 day, 1 week, 1 month, 1 quarter, 1 year or longer. In other embodiments, the expiration period may be at most 1 year, 1 quarter, 1 month, 1 week, 1 day or shorter. The subsequent analysis may include analyzing the new application and/or new document to update the classification engine 116.

Further aspects of the disclosure are discussed in the additional embodiments below. It should be understood that embodiments in this disclosure are exemplary only, and that other embodiments may include various combinations of features from other embodiments, as well as additional or fewer features.

In an exemplary embodiment, a method of training a classification engine 116 to determine associations between a document and key performance indicators includes: receiving a plurality of documents that include text descriptive of a respective project; clustering the documents based on the text, determining a set of labels for the clusters based on overlapping text in the documents in each cluster; and training the classification engine 116 using training data including the texts as samples and one or more of the clusters and the determined labels as ground truth. The text may include one or more of goals, objectives, products, applications, costs, personnel, or the like for the associated project. The labels may be KPIs for an entity associated with the projects.

In another exemplary embodiment, a method of evaluating a new project includes: using text of a new document associated with the new project as input for a trained classification engine 116, the classification engine 116 configured to assign labels, e.g., KPIs to the new document based on the training data; associating the assigned labels with the new project; tracking usage records for the new project; mapping the usage records to scores associated with the labels; generating a notification and/or a display that includes indications of the scores for the project and/or other information associated with the project and/or other projects for the entity.

In general, any process discussed in this disclosure that is understood to be computer-implementable, such as the process illustrated in FIG. 2, may be performed by one or more processors of a computer system, such as computer system 110, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as computer system 110, may include one or more computing devices. If the one or more processors of the computer system 110 are implemented as a plurality of processors, the plurality of processors may be included in a single computing device or distributed among a plurality of computing devices. If a computer system 110 comprises a plurality of computing devices, the memory of the computer system 110 may include the respective memory of each computing device of the plurality of computing devices.

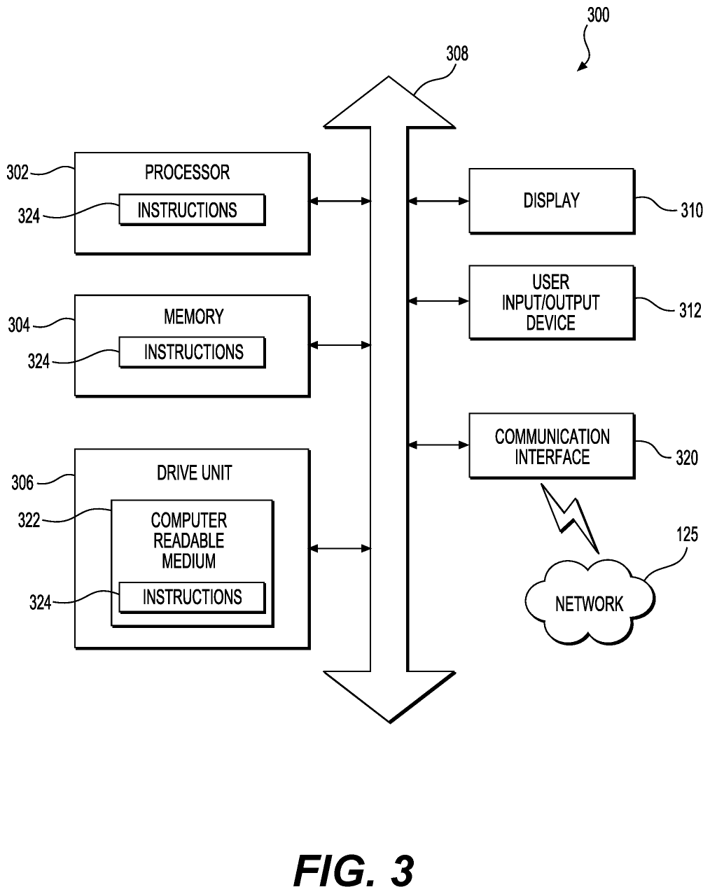

FIG. 3 is a simplified functional block diagram of a computer 300 that may be configured as a device for executing the methods of FIG. 2, according to exemplary embodiments of the present disclosure. FIG. 3 is a simplified functional block diagram of a computer that may be configured as the computer system 110 according to exemplary embodiments of the present disclosure. In various embodiments, any of the systems herein may be an assembly of hardware 300 including, for example, a data communication interface 320 for packet data communication. The platform also may include a central processing unit (“CPU”) 302, in the form of one or more processors, for executing program instructions. The platform may include an internal communication bus 308, and a storage unit 306 (such as ROM, HDD, SDD, etc.) that may store data on a computer readable medium 322, although the system 300 may receive programming and data via network communications. The system 300 may also have a memory 304 (such as RAM) storing instructions 324 for executing techniques presented herein, although the instructions 324 may be stored temporarily or permanently within other modules of system 300 (e.g., processor 302 and/or computer readable medium 322). The system 300 also may include input and output ports 312 and/or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer, an automobile entertainment system, a home entertainment system, etc. Also, the presently disclosed embodiments may be applicable to any type of Internet protocol.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to: the process shown in FIG. 2, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method comprising:
receiving, via one or more processors, a plurality of documents, wherein each of the plurality of documents includes a description of an application and an objective of the application;
extracting, via the one or more processors, the objective of the application from each of the received plurality of documents;
clustering, via the one or more processors, the plurality of documents to generate at least a first cluster of documents and a second cluster of documents;
determining, via the one or more processors, a first set of attributes associated with each of the documents included in the first cluster of documents and a second set of attributes associated with each of the documents included in the second cluster of documents;
training, via the one or more processors, a classification engine based on the plurality of documents, the extracted objectives, the first set of attributes, and the second set of attributes;
receiving, via the one or more processors, a new document including a description of a new application and an objective of the new application;
using, via the one or more processors, the classification engine to generate a set of attributes associated with the new document;
determining, via the one or more processors, a mapping of the set of attributes associated with the new document, the new application, and the objective of the new application;
assigning, via the one or more processors, the new application to a server and operating the new application on the server;
determining, via the one or more processors, a number of access requests to the server via an application program interface (API) of the server; and
evaluating, via the one or more processors, the new application based on the determined number of access requests to the server and the mapping.

2. The computer-implemented method of claim 1, wherein:
the first set of attributes associated with each of the documents included in the first cluster of documents comprises one or more key performance indicators (KPIs) associated with each of the documents included in the first cluster of documents,
the second set of attributes associated with each of the documents included in the second cluster of documents comprises one or more KPIs associated with each of the documents included in the second cluster of documents, and
the set of attributes associated with the new document comprises one or more KPIs associated with the new document.

3. The computer-implemented method of claim 1, wherein clustering the plurality of documents to generate at least the first cluster of documents and the second cluster of documents comprises:
clustering at least the first and second clusters of documents based on overlapping keywords used in each of the plurality of documents.

4. The computer-implemented method of claim 1, wherein:
determining the first set of attributes associated with each of the documents included in the first cluster of documents comprises:
identifying a plurality of overlapping key words used in each of the documents included in the first cluster of documents; and
determining one or more KPIs based on the identified plurality of overlapping keywords; and
the first set of attributes includes the determined one or more KPIs.

5. The computer-implemented method of claim 4, wherein determining one or more KPIs based on the identified plurality of overlapping keywords comprises:
receiving a mapping of a plurality of KPIs and a plurality of key words; and
using the received mapping to determine the one or more KPIs based on the identified plurality of overlapping keywords.

6. The computer-implemented method of claim 1, wherein:
determining the second set of attributes associated with each of the documents included in the second cluster of documents comprises:
identifying a plurality of overlapping key words used in each of the documents included in the second cluster of documents; and
determining one or more KPIs based on the identified plurality of overlapping keywords; and
the second set of attributes includes the determined one or more KPIs.

7. The computer-implemented method of claim 1, wherein determining the number of access requests to the server via the API of the server comprises:
obtaining an access log to the server; and
analyzing the access log to determine the number of access requests.

8. The computer-implemented method of claim 1, further comprising:
mapping the number of access requests to the mapping of the set of attributes associated with the new document, the new application, and the objective of the new application.

9. The computer-implemented method of claim 8, wherein:
the set of attributes associated with the new document comprises one or more KPIs associated with the new document, and
mapping the number of access requests to the mapping of the set of attributes associated with the new document, the new application, and the objective of the new application comprises mapping the determined number of access requests to the one or more KPIs associated with the new document and/or the objective of the new application.

10. The computer-implemented method of claim 1, wherein the classification engine comprises one or more neural networks.

11. A non-transitory computer-readable medium containing instructions that, when executed by a processor, cause the processor to perform a method comprising:
receiving a plurality of documents, wherein each of the plurality of documents includes a description of an application and an objective of the application;
extracting the objective of the application from each of the received plurality of documents;
clustering the plurality of documents to generate at least a first cluster of documents and a second cluster of documents;
determining a first set of attributes associated with each of the documents included in the first cluster of documents and a second set of attributes associated with each of the documents included in the second cluster of documents;
training a classification engine based on the plurality of documents, the extracted objectives, the first set of attributes, and the second set of attributes;
receiving a new document including a description of a new application and an objective of the new application;
using the classification engine to generate a set of attributes associated with the new document;
determining a mapping of the set of attributes associated with the new document, the new application, and the objective of the new application;
assigning the new application to a server and operating the new application on the server;
determining a number of access requests to the server via an API of the server; and
evaluating the new application based on the determined number of access requests to the server and the mapping.

12. The non-transitory computer-readable medium of claim 11, wherein:
the first set of attributes associated with each of the documents included in the first cluster of documents comprises one or more key performance indicators (KPIs) associated with each of the documents included in the first cluster of documents,
the second set of attributes associated with each of the documents included in the second cluster of documents comprises one or more KPIs associated with each of the documents included in the second cluster of documents, and
the set of attributes associated with the new document comprises one or more KPIs associated with the new document.

13. The non-transitory computer-readable medium of claim 11, wherein clustering the plurality of documents to generate at least the first cluster of documents and the second cluster of documents comprises clustering at least the first and second clusters of documents based on overlapping key words used in each of the plurality of documents.

14. The non-transitory computer-readable medium of claim 11, wherein:
determining the first set of attributes associated with each of the documents included in the first cluster of documents comprises:
identifying a plurality of overlapping key words used in each of the documents included in the first cluster of documents; and
determining one or more KPIs based on the identified plurality of overlapping keywords, wherein the first set of attributes includes the determined one or more KPIs; and
determining one or more KPIs based on the identified plurality of overlapping keywords comprises:
receiving a mapping of a plurality of KPIs and a plurality of key words; and
using the received mapping to determine the one or more KPIs based on the identified plurality of overlapping keywords.

15. The non-transitory computer-readable medium of claim 11, wherein:
determining the second set of attributes associated with each of the documents included in the second cluster of documents comprises:
identifying a plurality of overlapping key words used in each of the documents included in the second cluster of documents; and
determining one or more KPIs based on the identified plurality of overlapping key words; and
the second set of attributes includes the determined one or more KPIs.

16. The non-transitory computer-readable medium of claim 11, wherein determining the number of access requests to the server via the API of the server comprises:
obtaining an access log to the server; and
analyzing the access log to determine the number of access requests.

17. The non-transitory computer-readable medium of claim 11, the method further comprises mapping the number of access requests to the mapping of the set of attributes associated with the new document, the new application, and the objective of the new application.

18. The non-transitory computer-readable medium of claim 17, wherein:
the set of attributes associated with the new document comprises one or more KPIs associated with the new document, and
mapping the number of access requests to the mapping of the set of attributes associated with the new document, the new application, and the objective of the new application comprises mapping the determined number of access requests to the one or more KPIs associated with the new document and/or the objective of the new application.

19. The non-transitory computer-readable medium of claim 11, wherein the classification engine comprises one or more neural networks.

20. A computer-implemented method comprising:
receiving, via one or more processors, a plurality of documents, wherein each of the plurality of documents includes a description of an application and an objective of the application;
extracting, via the one or more processors, the objective of the application from each of the received plurality of documents;
clustering, via the one or more processors, the plurality of documents to generate at least a first cluster of documents and a second cluster of documents;
determining, via the one or more processors, a first set of attributes associated with each of the documents included in the first cluster of documents and a second set of attributes associated with each of the documents included in the second cluster of documents;
training, via the one or more processors, a classification engine based on the plurality of documents, the extracted objectives, the first set of attributes, and the second set of attributes;
receiving, via the one or more processors, a first new document including a first description of a first new application and an objective of the first new application;
using, via the one or more processors, the classification engine to generate a set of attributes associated with the first new document;
determining, via the one or more processors, a first mapping of the set of attributes associated with the first new document, the first new application, and the objective of the first new application;
assigning, via the one or more processors, the first new application to a first server and operating the first new application on the first server;
determining, via the one or more processors, a number of access requests to the first server via an API of the first server;
receiving, via the one or more processors, a second new document including a second description of a second new application and an objective of the second new application;
using, via the one or more processors, the classification engine to generate a set of attributes associated with the second new document;
determining, via the one or more processors, a second mapping of the set of attributes associated with the second new document, the second new application, and the objective of the second new application;
assigning, via the one or more processors, the second new application to a second server and operating the second new application on the second server;
determining, via the one or more processors, a number of access requests to the second server via an API of the second server; and
evaluating, via the one or more processors, the first new application and the second new application based on the number of access requests to the first server, the number of access requests to the second server, the first mapping, and the second mapping, wherein evaluating the first new application and the second new application comprises comparing the determined number of access requests to the first server and the determined number of access requests to the second server.
